(19) United States
(12) Patent Application Publication
(10) Pub. No.: US 2025/0236959 A1
(43) Pub. Date: Jul. 24, 2025

(54) ELECTROCHEMICAL METHOD OF RECYCLING AND REGENERATING TRANSITION METAL OXIDES

(71) Applicant: The Board of Trustees of the University of Illinois, Urbana, IL (US)

(72) Inventors: Paul V. Braun, Champaign, IL (US); Jarom Sederholm, Urbana, IL (US); Arghya Patra, Urbana, IL (US)

(21) Appl. No.: 19/175,586

(22) Filed: Apr. 10, 2025

Related U.S. Application Data
(63) Continuation-in-part of application No. PCT/US23/34518, filed on Oct. 5, 2023.
(60) Provisional application No. 63/414,956, filed on Oct. 11, 2022.

(51) Int. Cl. C25B 1/01; C25B 11/077; C25B 15/02

(52) U.S. Cl. CPC C25B 1/01; C25B 11/077; C25B 15/02

(57) ABSTRACT

An electrochemical method of recycling and regenerating transition metal oxides includes heating a mixture of salts to obtain a molten salt solution, and immersing a working electrode, a counter electrode and optionally a reference electrode into the molten salt solution, where the working electrode is electrically connected to a cathode material comprising a transition metal oxide. A voltage is applied to the working electrode, such that electrodissolution of the transition metal oxide occurs and an alkali metal species comprising lithium or sodium ions and a transition metal species comprising transition metal ions are produced in the molten salt solution. During application of the voltage and dissolution of the transition metal oxide, a regenerated transition metal oxide is concurrently electrochemically produced, e.g., in the form of a film or a powder.

### RELATED APPLICATIONS

The present patent document is a continuation-in-part of International Patent Application No. PCT/US2023/34518, which was filed on Oct. 5, 2023, and which claims the benefit of priority under 35 U.S.C. 119 (e) to U.S. Provisional Patent Application No. 63/414,956, which was filed on Oct. 11, 2022. Both of the aforementioned applications are hereby incorporated by reference in their entirety.

### STATEMENT OF FEDERALLY FUNDED RESEARCH OR DEVELOPMENT

This invention was made with government support under CMMI 20-37898 awarded by the National Science Foundation. The government has certain rights in the invention.

### TECHNICAL FIELD

The present disclosure is related generally to electrochemistry and more particularly to electrochemical recovery and regeneration of transition metal oxides from spent batteries or other sources.

### BACKGROUND

Sustainable battery production is a major challenge for the future of electrification and creation of a circular economy. The rise in battery usage, particularly in portable electronics and electric vehicles, has led to a massive increase in the demand for battery cathode materials.

Transition metal oxides (TMOs), such as lithium transition metal oxides, are critical materials for various industries and are employed as cathode materials for energy storage applications. These cathode materials constitute the most expensive part of battery cells. Projections suggest that energy storage TMOs may become scarce in the next few decades due to increasing demand for electric vehicles and portable electronics. These problems are only exacerbated when political instability and inhumane mining practices abroad are considered, as they may lead to further strain in the supply of energy storage TMO.

Increasing demand for energy storage TMOs may also lead to hundreds of thousands of pounds of energy storage pack waste and may pose dangers in terms of disposal. For example, battery packs have led to a number of fires in waste facilities. Effective recycling efforts would be beneficial to meet the demand for batteries and to deal with the related waste. The recovery of TMOs traditionally relies on hydrometallurgical or pyrometallurgical processing that breaks down the TMO into constituent elements and normally requires several steps with various chemicals (acids, bases, redox controlling agents) to remove, separate, and recover each element. The difficulty, cost, and overall effectiveness of recovering vital materials from TMO-containing materials are all bottlenecks in the recycling of TMOs. These problems are only exacerbated when environmental drawbacks of existing TMO recycling process are also considered.

Given that current battery recycling and recovery techniques involve multi-step regenerative processes that are costly and have significant environmental impact, it would be advantageous to have an environmentally responsible way to recycle used batteries into new batteries. An effective recycling approach could also significantly reduce the need for mining of new materials.

### BRIEF DESCRIPTION OF THE DRAWINGS

FIG. 1 is a flow chart of an exemplary method of recycling and/or regenerating transition metal oxides.

FIG. 2 is a simplified depiction of electrodissolution and electrochemical regeneration of a battery cathode material that comprises lithium cobalt oxide (LCO) in this example.

FIG. 3 is simplified depiction of (only) electrodissolution of a cathode material comprising LCO.

FIG. 4 shows a Pourbaix-like diagram depicting the conditions under which the electrodissolution of lithium cobalt oxide (LCO) may take place as a function of the concentration of cobalt ions in an anhydrous molten salt solution, where equations are plotted on a pCo²⁺ scale (−log[pCo²⁺]).

FIG. 5 shows cyclic voltammetry of a molten salt system measured at 335° C., 0.01 M of Co²⁺, and a scan rate of 20 mV/s with nickel foils functioning as both working and counter electrodes; sections are denoted with the electrochemical species most prevalent within the voltages and cobalt ion concentrations shown.

FIG. 6 shows cyclic voltammetry (CV) data providing evidence of cobalt enrichment after increasing levels of electrodissolution charge (measured in mAh) are passed in the electrodissolution molten salt solution (the working and counter electrodes are nickel foils, the reference electrode is a cobalt wire, and the temperature of operation is 300-350° C.). Evolution of the Co²⁺|Co³⁺ redox peak with passage of increasing charge can be seen; the arrows represent the direction of the CVs.

FIG. 7 shows the increment of the Co²⁺ complex in the solution measured by the movement of the Co²⁺|Co³⁺ redox peak, where the arrows indicate the shift in redox peaks of both LCO plating and LCO electrodissolution voltage.

FIG. 8 shows an Arrhenius style plot and fits of the exchange current density, i₀, at five concentrations (10⁻³ M, 10^{-2.5} M, 10⁻² M, 10^{-1.5} M, 0.1 M) of Co²⁺ ions.

FIG. 9 shows activation energies as a function of Co²⁺ ion concentration with 95% confidence intervals.

FIG. 10 shows an x-ray diffraction (XRD) pattern obtained from a regenerated LCO electrode at steps of 0.01 degrees from 10° to 80° using a copper Kα source.

FIG. 11 shows a scanning electron microscope (SEM) image of the surface of the LCO electrode produced from the molten salt solution after electrodissolution, where the SEM image was taken at 4300× magnification and 15.0 kV.

FIG. 12 shows the percent capacity and coulombic efficiency of batteries produced from the recovered and pristine materials after 100 charging/discharging cycles.

FIG. 13 shows discharge profiles of an LCO electrode produced from the molten salt bath after electrodissolution vs lithium; the order of the lines in the legend represents the order in which the measurements were taken, and all cycles were charged at a rate of C/10.

FIG. 14 shows the average long-term cycling of 2 cells produced using regenerated LCO; the cells ran at C/2 from 3.0 to 4.3V vs lithium.

FIG. 15 shows XRD patterns that represent counter electrodes during electrodissolution (only) and during single-step recovery (or regeneration) of the LCO; the XRD patterns were obtained at steps of 0.01 degrees from 10° to 80° using a copper Kα source.

FIG. 16 shows cycle life comparison of batteries produced using recovered cathodes (average of 2) produced by electrodeposition from a molten salt solution after electrodissolution, a pristine cathode produced by electrodeposition from pristine materials, and a single-step recovered cathode produced by simultaneous electrodissolution and electrodeposition and from a molten salt solution; single-step and recovered cathodes were cycled from 3-4.3V while pristine cathodes were cycled from 3-4.2V.

### DETAILED DESCRIPTION

A simple electrochemical method for the recovery of transition metal oxides from spent or new lithium- or sodium-ion batteries has been developed. In contrast to existing methods, the new electrochemical method may not require multiple processing steps to recover the transition metal oxides. Electrodissolution of transition metal oxides from sources such as electrodeposited battery cathodes, slurry cast battery cathodes, and transition metal oxide powders is possible, where electrodissolution refers to electrochemical reduction of the transition metal oxide to a soluble state. The technology is capable of regenerating transition metal oxides either during the electrodissolution process or after completion of the electrodissolution process. Thus, the present method differs from many other transition metal oxide recovery processes in that the transition metal oxide may be recovered instead of or in addition to the constituent elements of the oxide. This can simplify the recovery of transition metal oxides by eliminating the need for separation of recovery products. The process is also capable of extracting transition metals from the electrodissolved solution. The method may be applicable to transition metal oxides comprising transition metals from groups 5-12/group 13/low group 14-15 (e.g., Sn, Sb, Pb, Bi) of the periodic table, as well as alkali ion/alkaline earth ion intercalated versions of the same. Recovered or regenerated transition metal oxides are shown to have electrochemical performance comparable to that of electrodes produced using pristine transition metal oxides.

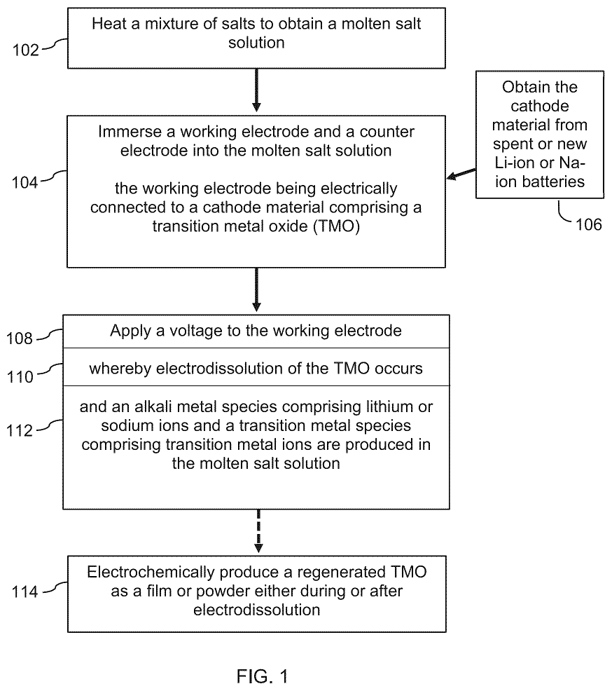

The electrochemical method of recycling and regenerating transition metal oxides is described below, in reference to FIG. 1. The method includes heating 102 a mixture of salts to obtain a molten salt solution, and immersing 104 a working electrode, a counter electrode and optionally a reference electrode into the molten salt solution. The working electrode is electrically connected to a cathode material comprising a transition metal oxide. The cathode material may be obtained 106 from spent or new lithium-ion or sodium-ion batteries. The process may be carried out in a crucible or reaction vessel capable of withstanding high temperatures and highly alkaline environments. To ensure immersion in the molten salt solution, the electrodes may be attached to a high-temperature lid that is electrically connected to a power supply capable of providing suitable voltages and currents for electrodissolution and electrodeposition. The electrochemical method may be carried out in an inert gas (e.g., nitrogen) atmosphere.

Referring again to FIG. 1, a voltage is applied 108 to the working electrode, and electrodissolution 110 of the transition metal oxide occurs. In other words, the transition metal oxide dissolves in the molten salt solution under the applied voltage. Consequently, an alkali metal species comprising lithium or sodium ions and a transition metal species comprising transition metal ions (e.g., cobalt, manganese or nickel ions) are produced 112 in the molten salt solution. The transition metal species may comprise a transition metal hydroxide such as cobalt, manganese or nickel hydroxide, and the alkali metal species may comprise a lithium or a sodium hydroxide. The rate at which electrodissolution takes place may depend on process factors such as operating voltage and/or material factors including available surface area of the transition metal oxide. The total amount of the transition metal oxide that is electrodissolved may depend on the amount of charge that has been passed towards electrodissolution. The process may be halted either when a sufficient amount of the transition metal species (e.g., Co²⁺) is obtained in the molten salt solution or when the counter electrode is completely passivated or oxidized. A regenerated transition metal oxide may be electrochemically produced 114 either during or after electrodissolution 110 as a film (via electrodeposition) or as a powder, as described below.

The cathode material may take the form of an electrodeposited battery cathode material, a slurry-cast battery cathode material, or transition metal oxide powders. The transition metal oxide may comprise a lithium transition metal oxide or a sodium transition metal oxide. Examples of suitable transition metal oxides may include lithium cobalt oxide (LCO), lithium manganese oxide (LMO), lithium nickel manganese cobalt oxide (NMC), and/or lithium nickel cobalt aluminum oxide (NCA). In some examples, the cathode material may further include, in addition to the transition metal oxide, an organic binder and/or carbon. In examples where the cathode material is obtained from spent or used lithium- or sodium-ion batteries, the method may first include dismantling a battery pack to obtain the cathode material. Other battery parts from the battery pack may also be reused or recycled.

The mixture of salts used to form the molten salt solution may include one or more hydroxides, one or more halides, one or more sulfates or persulfates, and/or one or more nitrates. More specifically, the mixture of salts may include LiOH, NaOH, KOH, RbOH, CSOH, NH₄OH, LiCl, NaCl, KCl, RbCl, CsCl, LiF, NaF, KF, RbF, CsF, LiBr, NaBr, KBr, RbBr, CsBr, LiI, NaI, KI, RbI, CsI, Li₂SO₄, Na₂SO₄, K₂SO₄, Rb₂SO₄, Cs₂SO₄, (NH₄)₂S₂O₈, LiNO₃, NaNO₃, KNO₃, RbNO₃, and/or CsNO₃. Typically, the mixture of salts comprises two or more hydroxides, such as lithium hydroxide and potassium hydroxide. A mass ratio of the lithium hydroxide to the potassium hydroxide may be in a range from about 0.5:8.5 to about 1.5:7.5, e.g., about 1:8. It may be advantageous to utilize a eutectic mixture of the salts, since the temperature required to melt the salts is decreased at the eutectic composition and thus the energy requirements of the process can be reduced. The mixture of salts is heated at or above the melting temperature of the mixture, which in some examples may be in a range from 100° C. to 800° C., from 100° C. to 350° C., and/or from 310° C. to 350° C.

The voltage applied to the working electrode may be selected to be in a range over which the predominant electrochemical reaction is reduction of the transition metal oxide from an insoluble to a soluble state. Typically, the applied voltage is from 0.1 V to 0.3 V to effect electrodissolution. Each electrode (working, counter, and optional reference electrode) comprises a current collector formed from an electrically conductive material, such as a metal or alloy, that is stable in the molten salt solution. The electrodes may take the form of foils, rods or wires. The working electrode supports the cathode material to be electrodissolved. A reference electrode may be employed to provide better control over the electrochemical system and method. The counter electrode is capable of oxidation to provide the balancing counter electrode reaction and may comprise nickel, stainless steel, or graphite. As the voltage is applied, the counter electrode may undergo oxidation or passivation, and/or be consumed. For example, nickel foils may oxidize to nickel oxide, and graphite rods may be consumed as carbon dioxide is formed. The counter electrode may be replaced after complete passivation or consumption. As discussed below, complete passivation of the counter electrode may be indicated by a rapid rise in counter electrode voltage while operating at the electrodissolution voltage.

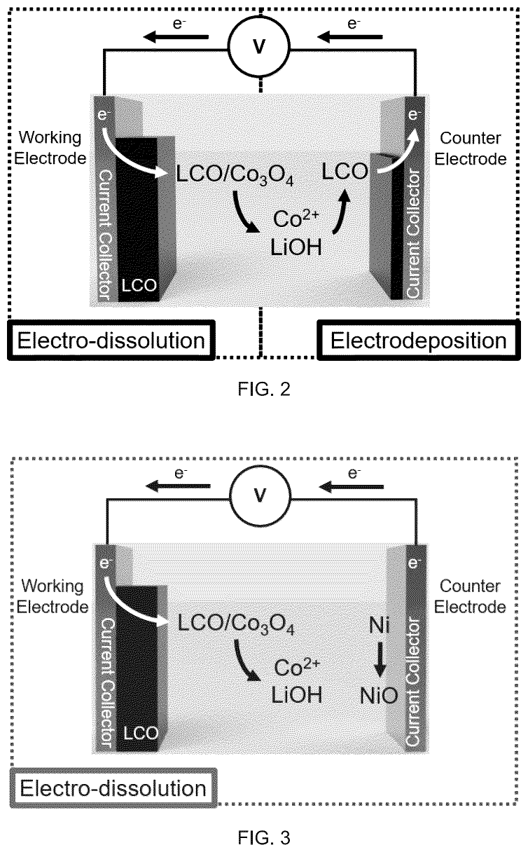

The electrochemical method may further include, as the voltage is applied and the transition metal oxide undergoes electrodissolution, concurrently electrochemical forming a regenerated transition metal oxide, either on the counter electrode or in the molten salt solution, from the electrodissolved alkali metal species and the transition metal species. More specifically, the regenerated transition metal oxide may be grown or electrodeposited on the counter electrode as a film, as illustrated in FIG. 2, where the exemplary cathode material comprises LCO, or precipitated in the molten salt solution as a powder. In the latter case, to inhibit or prevent growth of the regenerated metal oxide directly on the surface of the counter electrode, the surface may be modified or coated such that precipitation of the powder in the molten salt solution is promoted.

It is also contemplated that the transition metal ions and/or the lithium or sodium ions may be recovered from the molten salt solution after the electrodissolution of the transition metal oxide, e.g., via electrochemical extraction. Alternatively, after electrodissolution of the transition metal oxide, the molten salt solution including the transition metal ions and/or the lithium or sodium ions may be used to electrochemically form a regenerated transition metal oxide in the form of a film or a powder. In such an example, electrochemically forming the regenerated transition metal oxide may comprise immersing a new working electrode into the molten salt solution, and applying a voltage to the new working electrode, whereby the regenerated transition metal oxide is electrodeposited on the new working electrode as a film or is precipitated from the molten salt solution as a powder. After formation of the film or powder comprising the regenerated transition metal oxide, the film or powder may be washed with water, followed by drying.

Electrodeposition of a regenerated TMO film after electrodissolution differs from electrodeposition of a regenerated TMO film during electrodissolution in terms of what happens with the counter electrode during the electrodissolution process. Electrodissolution is illustrated in the exemplary electrochemical system of FIG. 3, which utilizes a cathode material comprising lithium cobalt oxide (LCO) and a counter electrode comprising nickel. As the voltage is applied, nickel on the counter electrode converts from nickel to nickel oxide in a process that may be referred to as passivation. When there is no more nickel available on the counter electrode surface, the counter electrode may begin to produce LCO from the lithium hydroxide and Co²⁺ in the electrodissolution bath. Accordingly, if concurrent formation of the regenerated TMO film during electrodissolution is desired, the counter electrode may be allowed to completely passivate, such that the counter electrode voltage rises to potentials where growth (regeneration) of the transition metal oxide is favorable. As indicated above, complete passivation of the counter electrode may be indicated by a rapid rise in counter electrode voltage while operating at the electrodissolution voltage. The counter electrode voltage can then stabilize at a potential where transition metal oxide (e.g., LCO) growth from (in this example) the lithium hydroxide and Co²⁺ is advantageous.

Alternatively, in order to avoid concurrent growth of the transition metal oxide during electrodissolution, the counter electrode may be removed before it becomes completely passivated. Therefore, when it is observed that the counter electrode voltage is increasing rapidly, the counter electrode may be replaced (e.g., with a new nickel foil) and the electrodissolution process may be resumed. Once electrodissolution is complete, the molten salt solution including the dissolved LCO may be employed for electrodeposition with a new working electrode that does not include a TMO cathode material. The regenerated transition metal oxide (e.g., LCO) may then be electrodeposited onto the new working electrode while the transition metal (e.g., cobalt metal) may be electrodeposited on the counter electrode.

Formation of a regenerated transition metal oxide as a powder may occur concurrently with electrodissolution or after electrodissolution is complete. In this case, a counter electrode having a surface engineered to inhibit the growth and adhesion of the regenerated transition metal oxide thereon may be employed, as indicated above, and the counter electrode preferably functions as an electrocatalyst for the precipitation of the regenerated transition metal oxide in the molten salt solution. The powder that is produced may be subsequently removed from the solution and washed with water to remove any molten hydroxides.

The regenerated transition metal oxide may be crystalline. As described above for the (initial) transition metal oxide, the regenerated transition metal oxide may comprise a lithium transition metal oxide or a sodium transition metal oxide, such as lithium cobalt oxide (LCO), lithium manganese oxide (LMO), lithium nickel manganese cobalt oxide (NMC), or lithium nickel cobalt aluminum oxide (NCA).

### Examples

The following examples demonstrate the recovery of TMOs from battery cathodes using simultaneous molten salt electrodissolution of used electrodes and electrodeposition of new electrodes that decreases battery recycling complexity, cost, and negative environmental impacts. The process utilized here can produce ultra-dense, battery grade materials from many TMO containing sources including commercial slurry cast battery cathodes, pure TMO battery cathode powders, and electrodeposited battery cathodes. Although the method is applicable to a range of TMOs as described above, this investigation focuses on lithium cobalt oxide (LCO) as the TMO of interest since LCO is a commercially used, high performance battery cathode material. In this work, electrodissolution and electrodeposition are explored first separately as independent processes, and the processes are then combined to demonstrate growth of new LCO from LCO-coated electrodes.

The investigation may be summarized as follows: The experimental design and the methods used in the recovery of LCO from battery cathodes are first described. Examples displaying the electrodissolution of LCO are provided. Evidence of LCO recovery from battery cathodes is provided and the recovered LCO is confirmed and shown to be phase pure and to perform within a battery cell.

### Methods

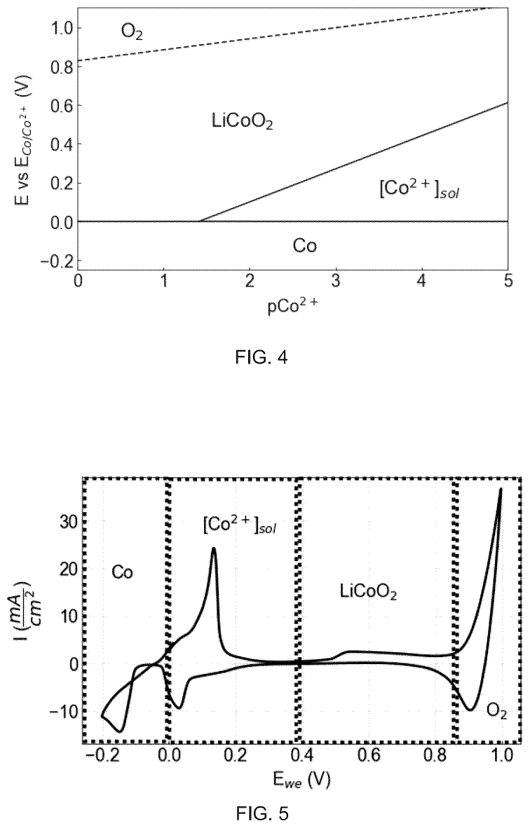

The conditions under which the electrodissolution of LCO within the molten salt will take place are described using a Pourbaix like diagram, as shown for example in FIG. 4. The lines are produced using the Nernst equation and represent equilibrium lines between different possible electrochemical products. The Co|Co²⁺ transition voltage is used as a psuedo reference voltage through the use of a cobalt wire. As such, all voltages shown throughout this work are versus the Co|Co²⁺ transition. The concentration of Co²⁺ in the molten salt solution is transitory throughout the electrodissolution process. It is therefore important to determine a suitable voltage range to perform the experiment as a function of cobalt ion concentration. The transition vertically across the equilibrium lines in FIG. 4 can be observed experimentally through cyclic voltammetry (CV), as shown in FIG. 5. By operating within the Co²⁺ stable region denoted on both graphs, electrodissolution of LCO becomes the dominant electrochemical reaction. If the process were performed at a voltage lower than the Co²⁺ stable region, conversion of LCO to cobalt metal would become the primary electrochemical reaction. Operating to the right of the Co²⁺ region would electrodeposit LCO rather than electro-dissolve LCO. Even higher voltages would lead to hydroxide decomposition. The concentration of water within the molten salt solution is also important. Maintenance of the concentration of water through drying beforehand provides conditions conducive to both electrodissolution and later recovery of LCO through electrodeposition.

All processes were performed using a three-electrode setup utilizing a cobalt wire as a pseudo reference electrode. The electrodes were dipped in a near eutectic, molten salt solution of lithium and potassium hydroxide. As discussed above, by utilizing a eutectic mixture, the temperature required to melt the salts is decreased, decreasing the energy requirements of the process. A nickel crucible capable of withstanding high temperatures and highly alkaline environments is used in conjunction with a high-temperature lid to create the reaction vessel. The three electrodes are attached to the high-temperature lid such that all three electrodes are sufficiently immersed in the molten salt. The lid is electrically connected to a power supply with capabilities sufficient to provide the required voltages and currents for electrodissolution and electrodeposition to take place. The solution is dried under vacuum and is mixed to provide homogeneous conditions for the electrodissolution and electrodeposition processes. The process is performed under nitrogen gas conditions. Three variants of LCO were used in this work: simulated slurry caste cathode powder consisting of 97/1.5/1.5 by weight LCO (Sigma Aldrich, 99.8% purity)/PVDF (Sigma Aldrich)/carbon black (Alfa Aeser), pure LCO powder (Sigma Aldrich, 99.8% purity), and electrodeposited LCO cathodes. All sources of LCO electro-dissolve and electroplate under similar operating conditions.

Electrodissolution and electrodeposition are investigated as follows. Electrodissolution is performed using a LCO containing source as the working electrode and a counter electrode capable of oxidation providing the balancing counter electrode reaction. Possible counter electrodes include nickel foils or graphite rods. The nickel foil are replaced once the surface has been fully oxidized and the graphite rods are replaced when all graphite has been consumed to produce carbon dioxide.

During this process, the concentration of cobalt ions in the bath increases; once the cobalt concentration is sufficient, electrodeposition from the bath is explored. During electrodeposition, the LCO containing electrode is replaced with a stainless steel electrode. LCO is then electrodeposited onto this electrode and cobalt metal is electrodeposited on the counter electrode. The recovered LCO electrochemical performance is evaluated in a coin cell constructed from stainless steel coin cell casings (MTI corporation), a commercial electrolyte (RD810, Gotion Inc.), and an appropriate separator (Cellgard, Whatman). The LCO is also examined using scanning electron microscopy (SEM) and x-ray diffraction (XRD).

Finally, to demonstrate concurrent electrodissolution and electrodeposition, a 3-electrode setup consisting of a LCO containing source as a working electrode and a stainless steel film as the counter electrode is used. The stainless steel film is prepared beforehand by electrodepositing a seed layer of LCO. While not absolutely necessary, the seed layer improves the conformity of the grown or regenerated LCO. The LCO produced is then evaluated by XRD, SEM, and electrochemically in a coin cell similar to as previously mentioned.

### Results and Discussion

### LCO Electrodissolution

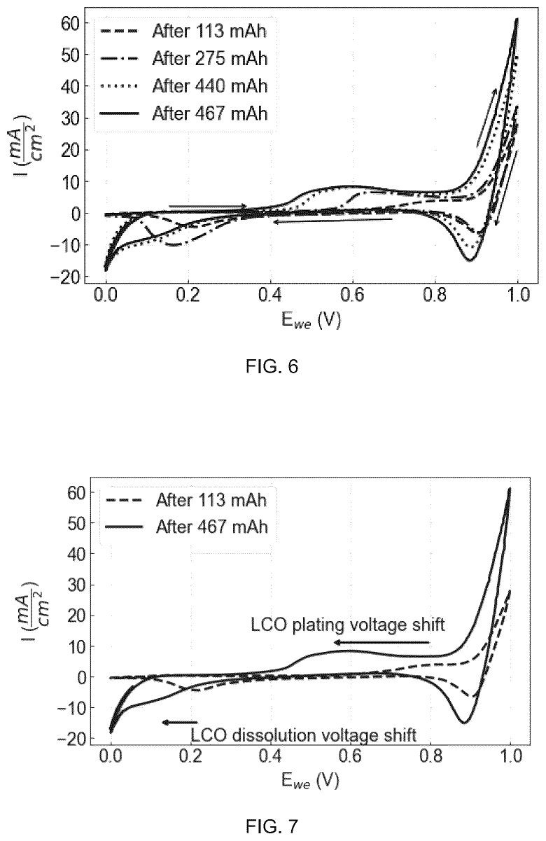

The increase of cobalt ions in solution from the electrodissolution of LCO is observable through multiple metrics, including CV. FIG. 6 contains several cyclic voltammograms obtained from a nickel working electrode with a nickel counter electrode and a cobalt wire as a pseudo reference electrode in the molten salt regenerative solution after increasing amounts of electrodissolution charge have been applied, and thus with various concentrations of Co²⁺ in the molten salt solution. The location of the redox peaks correlated with the Co²⁺|Co³⁺ are expected to decrease as the concentration of Co²⁺ in the regenerative solution increases, as shown in FIG. 4. This is shown experimentally as the Co²⁺|Co³⁺ peaks, denoted as LCO plating voltage and LCO dissolution voltage in FIG. 7, shift to the left as the amount of electrodissolution charge passed increases, which is indicative of an increase in the concentration of Co²⁺. All other conditions through electrodissolution are the same except for a negligible increase in LiOH. Further evidence of electrodissolution of LCO into the molten salt bath and increasing Co²⁺ concentrations can be seen visually. A clear visual example of electrodissolution is the color of the molten salt bath before and after electrodissolution. Before electrodissolution, the molten salt is a transparent liquid. After electrodissolution, the molten salt bath is deep blue. XRD plots of the nickel counter electrodes used during this process show that no other product is formed on the surface of the nickel counter electrodes other than nickel oxide. The electrodissolution process is stopped either when a sufficient amount of Co²⁺ is in solution, or, when using a nickel foil, the nickel counter electrode is completely passivated. A rapid rise in the counter electrode voltage, e.g., an increase of over 0.3-0.4 V in about 2 min or less, indicates complete passivation. At this point, the nickel counter electrode is replaced in order to continue to electrodissolve LCO. Graphite rods can be used in place of nickel foils so that the oxidation process produces carbon dioxide.

The kinetics of the electrodissolution of LCO was explored using Equation 1 as the proposed reaction of interest. This reaction was evaluated using the Butler-Volmer equation shown in Equation 2.

$${LiCoO}_{2} + {H}_{2} O + {e}^{{}_{-}} ↔ CoO + LiOH + {OH}^{-} \qquad ( 1 )$$

$$i = {i}_{0} [ {e}^{- α f η} - {e}^{( 1 - α ) f η} ] \qquad ( 2 )$$

$${i}_{0} ( T ) = A exp [ - {E}_{a} / RT ] \qquad ( 3 )$$

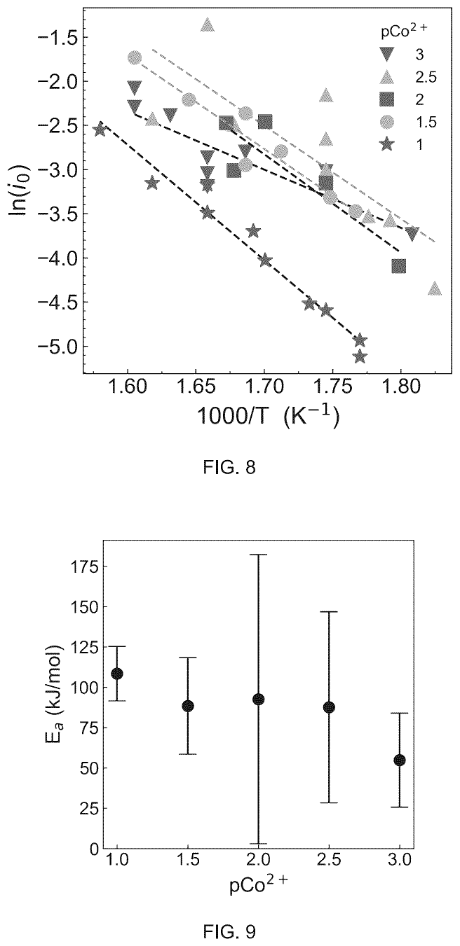

Operating voltages near the open circuit voltage were utilized in order to ensure mass transfer effects were avoided as required for Butler-Volmer kinetics. The current responses at each of the voltages were fit to the Butler-Volmer equation to determine the exchange current density, i₀, and the transfer coefficient, α with f representing Faraday's constant divided by the product of the gas constant and temperature. i₀ is dependent on temperature as shown in Equation 3 and by fitting i₀ values to an Arrhenius equation as shown in FIG. 8, the activation energy (Ea) can be determined at five [Co²⁺] from 10⁻³ M to 0.1M. The activation energy obtained from fitting the data to the Arrhenius equation is shown in FIG. 9. The error bars attached to the activation energy values represent 95% confidence intervals based of the regression of the Arrhenius equation fit to the i₀ data. These graphs show that activation energy of this process is near 90-100 kJ/mol. The a values gathered from the fit were most often at or near unity.

### LCO Electrodeposition

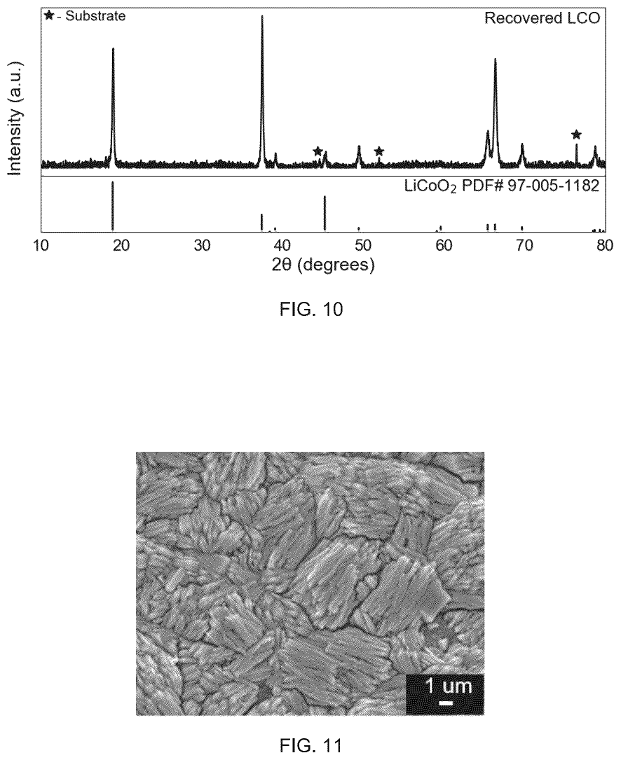

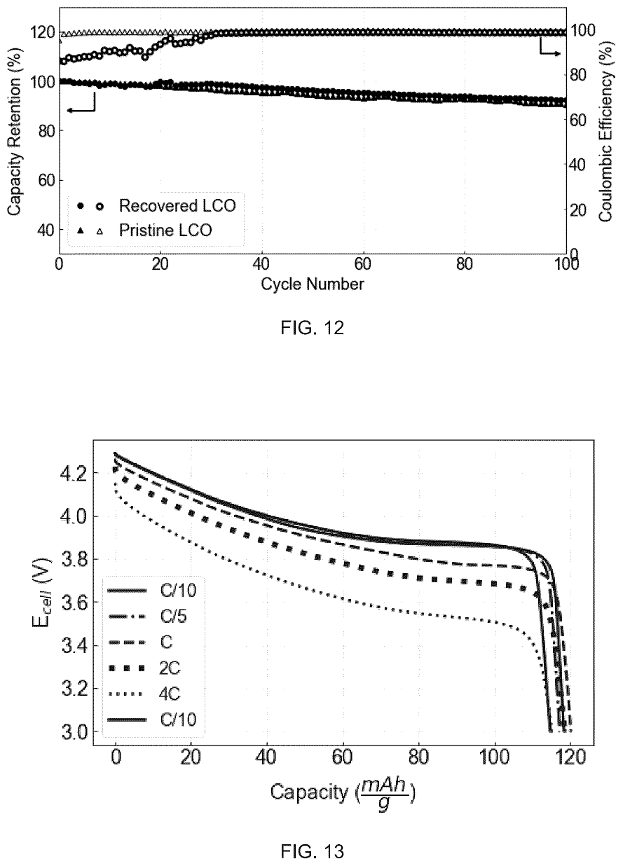

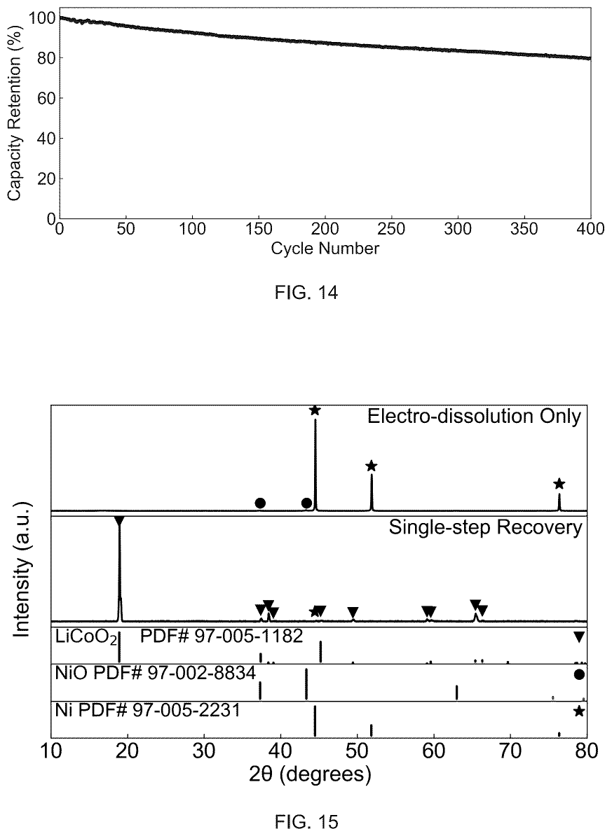

Once the Co²⁺ concentration is sufficient, the same molten salt bath used for electrodissolution can be used for electrodeposition of LCO cathodes. XRD confirms that the electrodeposited material is regenerated LCO. Referring to FIG. 10, the XRD pattern shows only LCO peaks and a few peaks related to the nickel substrate the LCO was grown on. The change in peak intensity from the standard LCO signal (PDF #97-005-1182) is a result of the orientation of the LCO. The highly crystalline <110> facet of LCO is observable under SEM, as can be observed in FIG. 11. Electrodeposited LCO samples were used for electrodes in a coin cell battery with lithium foil anodes. FIG. 12 shows the coulombic efficiency and the capacity retention over 100 cycles of cells containing cathodes made from both regenerated (or “recovered”) LCO and pristine LCO. The regenerated LCO performs similarly to the pristine material in terms of both capacity retention and cyclability. The initial drop in efficiency from the regenerated LCO is due to the recovered material being over-lithiated during electrodeposition. The excess lithium in the regenerated LCO transfers over the first few cycles to the lithium anode without returning to the cathode. The cell formed using regenerated LCO was then tested to determine its discharging rate performance, as shown in FIG. 13. The cell exhibited good discharge rate performance in line with performance of the initial LCO. The graph shows the capacity going to about 120 mAh/g. The expected value is near 140 mAh/g. A likely reason for this small deviation is due to uncertainty in the mass measurement of the cathode active material. The cyclability of the recovered LCO cell over extended cycling was evaluated, as shown in FIG. 14. The data ends once the percent capacity retention drops below 80% as that is the current industry standard for when a battery has reached “end-of-life.” The data of FIG. 14 show that on average the cells containing recovered LCO cycle at least 400 times with 80% capacity at a charge/discharge rate of C/2 from 3.0V to 4.3V versus lithium, with some cells retaining 80% capacity retention for 500 cycles.

### Simultaneous LCO Electrodissolution and Electrodeposition

In a real application, electrodissolution and electrodeposition (or more broadly speaking, regeneration) may be combined in what may be referred to as a single-step recovery process, as illustrated in FIG. 2 for an exemplary electrochemical system utilizing LCO as the cathode material. Importantly, this approach neither requires a sacrificial counter electrode nor results in metal plating on the counter electrode. For successful LCO growth, the counter electrode (typically Ni) is preferably oxidized or otherwise passivated such that the counter electrode voltage rises to potentials where LCO growth is favorable. A simple way to passivate the counter electrode is to electrodeposit a thin layer of the transition metal oxide (e.g., LCO) on the surface of the counter electrode; thus, the counter electrode voltage may lie within the voltage range where LCO is stable, as shown in FIG. 4.

The faradaic efficiency of the single step recovery process was evaluated by measuring the amount of LCO electrodeposited on the sample in comparison to how much charge was passed. As a part of this process, the sample was washed after the experiment was complete to remove any residual molten salt and then dried to remove any water. The process was calculated to have a faradaic efficiency as high as 75%. A comparison of the XRD patterns of the counter electrodes used in electrodissolution (only) versus single-step recovery is shown in FIG. 15. The XRD confirms the growth of LCO using single-step regeneration; the single-step recovery counter electrode shows LCO related peaks while the counter electrode used for electrodissolution shows only peaks from the nickel foil. Included for reference in FIG. 15 are the nickel (PDF #97-005-2231), nickel oxide (PDF #97-002-8834), and LiCoO₂ (PDF #97-005-1182) peak positions. LCO growth is also observed via SEM, where characteristic LCO crystals are seen on the counter electrode.

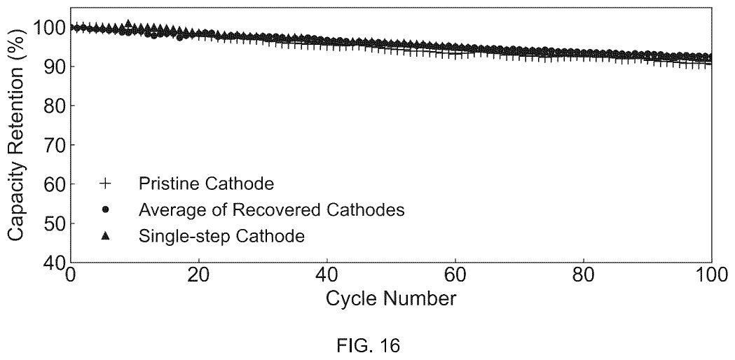

The energy storage capabilities of LCO produced from this method were then evaluated by using the LCO as a cathode in a coin cell with lithium metal as the anode. FIG. 16 shows the performance of this single-step cathode in comparison to coin cells produced using a pristine LCO and the recovered LCO cathodes from the electrodeposition section of this work. Recovered and single-step cells were cycled at a rate of C/2 from 3V to 4.3V vs lithium while the pristine cell was cycled from 3V to 4.2V. The LCO produced using the single-step process has properties similar to cathodes produced from recovered materials and pristine materials.

In summary, this disclosure has described a novel single-step method for recovering transition metal oxides such as lithium cobalt oxide, a critical energy resource, from battery materials using molten salt electrodissolution and electrodeposition. Cathodes made using the materials recovered using this approach have shown to have high rate capability and cyclability similar to those made from pristine materials. This method is advantageous for the current battery materials sustainability climate and is believed to be superior to current battery recycling methods in terms of recycling costs and total impact on human health, the ecosystem, and global resources. It is believed that application of this method to an industrial scale would not only be economical, but may provide a powerful new process required for the continued creation of a green energy society.

The subject matter of this disclosure may also relate to the following aspects:

A first aspect relates to an electrochemical method of recycling and regenerating transition metal oxides, the electrochemical method comprising: heating a mixture of salts to obtain a molten salt solution; immersing a working electrode, a counter electrode and a reference electrode into the molten salt solution, the working electrode being electrically connected to a cathode material comprising a transition metal oxide; and applying a voltage to the working electrode, whereby electrodissolution of the transition metal oxide occurs, thereby producing an alkali metal species comprising lithium or sodium ions and a transition metal species comprising transition metal ions in the molten salt solution.

A second aspect relates to the electrochemical method of the first aspect, wherein the cathode material is obtained from spent or new lithium-ion or sodium-ion batteries.

A third aspect relates to the electrochemical method the first or second aspect, wherein the cathode material comprises an electrodeposited battery cathode material, a slurry-cast battery cathode material, or transition metal oxide powders.

A fourth aspect relates to the electrochemical method of any preceding aspect, wherein the transition metal oxide comprises: a lithium transition metal oxide which may be selected from the group consisting of: lithium cobalt oxide (LCO), lithium manganese oxide (LMO), lithium nickel manganese cobalt oxide (NMC), and lithium nickel cobalt aluminum oxide (NCA), or a sodium transition metal oxide.

A fifth aspect relates to the electrochemical method of any preceding aspect, wherein the cathode material further comprises, in addition to the transition metal oxide, an organic binder and/or carbon.

A sixth aspect relates to the electrochemical method of any preceding aspect, wherein the molten salt solution comprises one or more hydroxides, one or more halides, one or more sulfates or persulfates, and/or one or more nitrates.

A seventh aspect relates to the electrochemical method of any preceding aspect, wherein the molten salt solution comprises one or more of: LiOH, NaOH, KOH, RbOH, CSOH, NH₄OH, LiCl, NaCl, KCl, RbCl, CsCl, LIF, NaF, KF, RbF, CsF, LiBr, NaBr, KBr, RbBr, CsBr, LiI, NaI, KI, RbI, CsI, Li₂SO₄, Na₂SO₄, K₂SO₄, Rb₂SO₄, Cs₂SO₄, (NH₄)₂S₂O₈, LiNO₃, NaNO₃, KNO₃, RbNO₃, and/or CsNO₃.

An eighth aspect relates to the electrochemical method of any preceding aspect, wherein the mixture of salts comprises two or more hydroxides.

A ninth aspect relates to the electrochemical method of any preceding aspect, wherein the mixture of salts comprises lithium hydroxide and potassium hydroxide.

A tenth aspect relates to the electrochemical method of the preceding aspect, wherein a mass ratio of the lithium hydroxide to the potassium hydroxide is in a range from about 0.5:8.5 to about 1.5:7.5, or is about 1:8.

An eleventh aspect relates to the electrochemical method of any preceding aspect, wherein a mass ratio of the salts is at or near a eutectic composition of the mixture.

A twelfth aspect relates to the electrochemical method of any preceding aspect, wherein the mixture of salts is heated at or above a melting temperature of the mixture.

A thirteenth aspect relates to the electrochemical method of any preceding aspect, wherein the mixture of salts is heated to a temperature in a range from 100° C. to 800° C., from 100° C. to 350° C., and/or from 310° C. to 350° C.

A fourteenth aspect relates to the electrochemical method of any preceding aspect, wherein the transition metal ions comprise cobalt ions, manganese ions, or nickel ions.

A fifteenth aspect relates to the electrochemical method of any preceding aspect, wherein the transition metal species comprises a transition metal hydroxide, and wherein the alkali metal species comprises a lithium or a sodium hydroxide.

A sixteenth aspect relates to the electrochemical method of the preceding aspect, wherein the transition metal hydroxide is selected from the group consisting of: a cobalt hydroxide, a manganese hydroxide, and a nickel hydroxide.

A seventeenth aspect relates to the electrochemical method of any preceding aspect, wherein the voltage is in a range from 0.1 V to 0.3 V.

An eighteenth aspect relates to the electrochemical method of any preceding aspect, wherein the voltage is in a range over which reduction of the transition metal oxide from an insoluble to a soluble state is a predominant electrochemical reaction.

A nineteenth aspect relates to the electrochemical method of any preceding aspect, wherein the reference electrode comprises a material stable in the molten salt solution.

A twentieth aspect relates to the electrochemical method of any preceding aspect, wherein the reference electrode comprises cobalt.

A twenty-first aspect relates to the electrochemical method of any preceding aspect, wherein the counter electrode comprises nickel or graphite (e.g., nickel foils or graphite rods).

A twenty-second aspect relates to the electrochemical method of any preceding aspect, wherein, during application of the voltage, the counter electrode undergoes oxidation or passivation, and/or is consumed.

A twenty-third aspect relates to the electrochemical method of any preceding aspect, further comprising, during the electrodissolution of the transition metal oxide and the application of the voltage, concurrently electrochemically producing a regenerated transition metal oxide from the alkali metal species and the transition metal species in the molten salt solution.

A twenty-fourth aspect relates to the electrochemical method of the preceding aspect, wherein the regenerated transition metal oxide has the form of a film.

A twenty-fifth aspect relates to the electrochemical method of the twenty-second or twenty-third aspect, wherein the regenerated transition metal oxide grows on the counter electrode following complete passivation of the counter electrode.

A twenty-sixth aspect relates to the electrochemical method of the twenty-third aspect, wherein the regenerated transition metal oxide has the form of a powder.

A twenty-seventh aspect relates to the electrochemical method of the preceding aspect, wherein a surface of the counter electrode is modified or coated to inhibit or prevent growth of the regenerated metal oxide directly on the surface, thereby promoting precipitation of the powder in the molten salt solution.

A twenty-eighth aspect relates to the electrochemical method of any preceding aspect, wherein the regenerated transition metal oxide is crystalline.

A twenty-ninth aspect relates to the electrochemical method of any preceding aspect, wherein the regenerated transition metal oxide comprises: a lithium transition metal oxide which may be selected from the group consisting of: lithium cobalt oxide (LCO), lithium manganese oxide (LMO), lithium nickel manganese cobalt oxide (NMC), and lithium nickel cobalt aluminum oxide (NCA), or a sodium transition metal oxide.

A thirtieth aspect relates to the electrochemical method of any preceding aspect, further comprising washing the regenerated transition metal oxide with water, followed by drying.

A thirty-first aspect relates to the electrochemical method of any preceding aspect, further comprising replacing the counter electrode with a new counter electrode if complete passivation of the counter electrode occurs, complete passivation being indicated by a rapid increase in counter electrode voltage.

A thirty-second aspect relates to the electrochemical method of any preceding aspect, further comprising, after the electrodissolution of the transition metal oxide, recovering the transition metal ions and/or the lithium or sodium ions from the molten salt solution.

A thirty-third aspect relates to the electrochemical method of the preceding aspect, wherein recovering the transition metal ions and/or the lithium or sodium ions comprises electrochemical extraction.

A thirty-fourth aspect relates to the electrochemical method of any preceding aspect, further comprising, after the electrodissolution of the transition metal oxide, utilizing the molten salt solution including the transition metal ions and/or the lithium or sodium ions to electrochemically form a regenerated transition metal oxide.

A thirty-fifth aspect relates to the electrochemical method of the preceding aspect, wherein electrochemically forming a regenerated transition metal oxide comprises: immersing a new working electrode into the molten salt solution; and applying a voltage to the new working electrode, whereby the regenerated transition metal oxide is electrodeposited on the new working electrode as a film or is precipitated from the molten salt solution as a powder.

A thirty-sixth aspect relates to the electrochemical method of the thirty-fourth or thirty-fifth aspect, wherein the regenerated transition metal oxide is crystalline.

A thirty-seventh aspect relates to the electrochemical method of any of the thirty-fourth through the thirty-sixth aspects, wherein the regenerated transition metal oxide comprises: a lithium transition metal oxide which may be selected from the group consisting of: lithium cobalt oxide (LCO), lithium manganese oxide (LMO), lithium nickel manganese cobalt oxide (NMC), and lithium nickel cobalt aluminum oxide (NCA), or a sodium transition metal oxide.

A thirty-eighth aspect relates to the electrochemical method of any of the thirty-fourth through the thirty-seventh aspects, further comprising washing the regenerated transition metal oxide with water, followed by drying.

A thirty-ninth aspect relates to an electrochemical method of recycling and regenerating transition metal oxides, the electrochemical method comprising: heating a mixture of salts to obtain a molten salt solution; immersing a working electrode, a counter electrode and a reference electrode into the molten salt solution, the working electrode being electrically connected to a cathode material comprising a transition metal oxide; applying a voltage to the working electrode, whereby electrodissolution of the transition metal oxide occurs, thereby producing an alkali metal species comprising lithium or sodium ions and a transition metal species comprising transition metal ions in the molten salt solution; and during the electrodissolution of the transition metal oxide and the application of the voltage, concurrently electrochemically producing a regenerated transition metal oxide.

A fortieth aspect relates the method of the preceding aspect, wherein concurrently electrochemically producing the regenerated transition metal oxide comprises: concurrently growing the regenerated transition metal oxide on the counter electrode from the alkali metal species and the transition metal species in the molten salt solution.

A forty-first aspect relates to the electrochemical method of the thirty-ninth or fortieth aspect, wherein the regenerated transition metal oxide has the form of a film.

A forty-second aspect relates to the electrochemical method of any of the thirty-ninth through the forty-first aspects, wherein the regenerated transition metal oxide grows on the counter electrode following complete passivation of the counter electrode.

A forty-third aspect relates to the electrochemical method of the thirty-ninth aspect, wherein concurrently electrochemically producing the regenerated transition metal oxide comprises: concurrently precipitating a powder comprising the regenerated transition metal oxide from the alkali metal species and the transition metal species in the molten salt solution.

A forty-fourth aspect relates to the electrochemical method of the forty-third aspect, wherein a surface of the counter electrode is modified or coated to inhibit or prevent growth of the regenerated transition metal oxide directly on the surface, thereby promoting precipitation of the powder in the molten salt solution.

A forty-fifth aspect relates to the electrochemical method of any of the thirty-ninth through the forty-fourth aspects, wherein the regenerated transition metal oxide is crystalline.

A forty-sixth aspect relates to the electrochemical method of any of the thirty-ninth through the forty-fifth aspects, wherein the transition metal oxide and the regenerated transition metal oxide comprise: a lithium transition metal oxide, which may be selected from the group consisting of: lithium cobalt oxide (LCO), lithium manganese oxide (LMO), lithium nickel manganese cobalt oxide (NMC), and lithium nickel cobalt aluminum oxide (NCA), or a sodium transition metal oxide.

A forty-seventh aspect relates to the electrochemical method of any of the thirty-ninth through the forty-fifth aspects, wherein the cathode material is obtained from spent or new lithium-ion or sodium-ion batteries.

A forty-eighth aspect relates to the electrochemical method of any of the thirty-ninth through the forty-fifth aspects, wherein the cathode material comprises an electrodeposited battery cathode material, a slurry-cast battery cathode material, or transition metal oxide powders.

A forty-ninth aspect relates to the electrochemical method of any of the thirty-ninth through the forty-sixth aspects, wherein the cathode material further comprises, in addition to the transition metal oxide, an organic binder and/or carbon.

A fiftieth aspect relates to the electrochemical method of any of the thirty-ninth through the forty-seventh aspects, wherein the molten salt solution comprises one or more hydroxides, one or more halides, one or more sulfates or persulfates, and/or one or more nitrates.

A fifty-first aspect relates to the electrochemical method of any of the thirty-ninth through the fiftieth aspects, wherein the molten salt solution comprises one or more of: LiOH, NaOH, KOH, RbOH, CSOH, NH₄OH, LiCl, NaCl, KCl, RbCl, CsCl, LIF, NaF, KF, RbF, CsF, LiBr, NaBr, KBr, RbBr, CsBr, LiI, NaI, KI, RbI, CsI, Li₂SO₄, Na₂SO₄, K₂SO₄, Rb₂SO₄, CS₂SO₄, (NH₄)₂S₂O₈, LiNO₃, NaNO₃, KNO₃, RbNO₃, and/or CsNO₃.

A fifty-second aspect relates to the electrochemical method of any of the thirty-ninth through the fifty-first aspects, wherein the mixture of salts comprises two or more hydroxides.

A fifty-third aspect relates to the electrochemical method of any of the thirty-ninth through the fifty-second aspects, wherein the mixture of salts comprises lithium hydroxide and potassium hydroxide.

A fifty-fourth aspect relates to the electrochemical method of any of the thirty-ninth through the fifty-third aspects, wherein a mass ratio of the lithium hydroxide to the potassium hydroxide is in a range from about 0.5:8.5 to about 1.5:7.5, or is about 1:8.

A fifty-fifth aspect relates to the electrochemical method of any of the thirty-ninth through the fifty-fourth aspects, wherein a mass ratio of the salts is at or near a eutectic composition of the mixture.

A fifty-sixth aspect relates to the electrochemical method of any of the thirty-ninth through the fifty-fifth aspects, wherein the mixture of salts is heated at or above a melting temperature of the mixture.

A fifty-seventh aspect relates to the electrochemical method of any of the thirty-ninth through the fifty-sixth aspects, wherein the mixture of salts is heated to a temperature in a range from 100° C. to 800° C., from 100° C. to 350° C., and/or from 310° C. to 350° C.

A fifty-eighth aspect relates to the electrochemical method of any of the thirty-ninth through the fifty-seventh aspects, wherein the transition metal ions comprise cobalt ions, manganese ions, or nickel ions.

A fifty-ninth aspect relates to the electrochemical method of any of the thirty-ninth through the fifty-eighth aspects, wherein transition metal species comprises a transition metal hydroxide, and wherein the alkali metal species comprises a lithium or sodium hydroxide.

A sixtieth aspect relates to the electrochemical method of the fifty-ninth aspect, wherein the transition metal hydroxide is selected from the group consisting of: a cobalt hydroxide, a manganese hydroxide, and a nickel hydroxide.

A sixty-first aspect relates to the electrochemical method of any of the thirty-ninth through the sixtieth aspects, wherein the voltage is in a range from 0.1 V to 0.3 V.

A sixty-second aspect relates to the electrochemical method of any of the thirty-ninth through the sixty-first aspects, wherein the voltage is in a range over which reduction of the transition metal oxide from an insoluble to a soluble state is a predominant electrochemical reaction.

A sixty-third aspect relates to the electrochemical method of any of the thirty-ninth through the sixty-second aspects, wherein the reference electrode comprises a material stable in the molten salt solution.

A sixty-fourth aspect relates to the electrochemical method of any of the thirty-ninth through the sixty-fifth aspects, wherein the reference electrode comprises cobalt.

A sixty-fifth aspect relates to the electrochemical method of any of the thirty-ninth through the sixty-fourth aspects, wherein the counter electrode comprises nickel or graphite (e.g., nickel foils or graphite rods).

A sixty-sixth aspect relates to the electrochemical method of any of the thirty-ninth through the sixty-fifth aspects, wherein, during application of the voltage, the counter electrode undergoes oxidation or passivation.

To clarify the use of and to hereby provide notice to the public, the phrases “at least one of <A>, <B>, . . . and <N>” or “at least one of <A>, <B>, . . . or <N>” or “at least one of <A>, <B>, . . . <N>, or combinations thereof” or “<A>, <B>, and/or <N>” are defined by the Applicant in the broadest sense, superseding any other implied definitions hereinbefore or hereinafter unless expressly asserted by the Applicant to the contrary, to mean one or more elements selected from the group comprising A, B, . . . and N. In other words, the phrases mean any combination of one or more of the elements A, B, . . . or N including any one element alone or the one element in combination with one or more of the other elements which may also include, in combination, additional elements not listed. Unless otherwise indicated or the context suggests otherwise, as used herein, “a” or “an” means “at least one” or “one or more.”

While various embodiments have been described, it will be apparent to those of ordinary skill in the art that many more embodiments and implementations are possible. Accordingly, the embodiments described herein are examples, not the only possible embodiments and implementations.

In addition to the features mentioned in each of the independent aspects enumerated above, some examples may show, alone or in combination, the optional features mentioned in the dependent aspects and/or as disclosed in the description above and shown in the figures.

1. An electrochemical method of recycling and regenerating transition metal oxides, the electrochemical method comprising:
heating a mixture of salts to obtain a molten salt solution;
immersing a working electrode, a counter electrode and optionally a reference electrode into the molten salt solution, the working electrode being electrically connected to a cathode material comprising a transition metal oxide; and
applying a voltage to the working electrode, whereby electrodissolution of the transition metal oxide occurs, thereby producing an alkali metal species comprising lithium or sodium ions and a transition metal species comprising transition metal ions in the molten salt solution.

2. The electrochemical method of claim 1, wherein the cathode material is obtained from a spent or new lithium-ion or sodium-ion battery.

3. The electrochemical method of claim 1, wherein the transition metal oxide comprises:
a lithium transition metal oxide selected from the group consisting of:
lithium cobalt oxide (LCO), lithium manganese oxide (LMO), lithium nickel manganese cobalt oxide (NMC), and lithium nickel cobalt aluminum oxide (NCA), or a sodium transition metal oxide.

4. The electrochemical method of claim 1, wherein the cathode material further comprises, in addition to the transition metal oxide, an organic binder and/or carbon.

5. The electrochemical method of claim 1, wherein the molten salt solution comprises one or more hydroxides, one or more halides, one or more sulfates or persulfates, and/or one or more nitrates.

6. The electrochemical method of claim 1, wherein the mixture of salts comprises lithium hydroxide and potassium hydroxide.

7. The electrochemical method of claim 6, wherein a mass ratio of the lithium hydroxide to the potassium hydroxide is in a range from about 0.5:8.5 to about 1.5:7.5.

8. The electrochemical method of claim 1, wherein the transition metal ions comprise cobalt ions, manganese ions, or nickel ions.

9. The electrochemical method of claim 1, wherein the transition metal species comprises a transition metal hydroxide, and
wherein the alkali metal species comprises a lithium or a sodium hydroxide.

10. The electrochemical method of claim 1, wherein the voltage is in a range from 0.1 V to 0.3 V.

11. The electrochemical method of claim 1, wherein the voltage is in a range over which reduction of the transition metal oxide from an insoluble to a soluble state is a predominant electrochemical reaction.

12. The electrochemical method of claim 1, further comprising, during the electrodissolution of the transition metal oxide and the application of the voltage, concurrently electrochemically producing a regenerated transition metal oxide from the alkali metal species and the transition metal species in the molten salt solution.

13. The electrochemical method of claim 1, further comprising, after the electrodissolution of the transition metal oxide, recovering the transition metal ions and/or the lithium or sodium ions from the molten salt solution.

14. The electrochemical method of claim 1, further comprising, after the electrodissolution of the transition metal oxide, utilizing the molten salt solution including the transition metal ions and/or the lithium or sodium ions to electrochemically form a regenerated transition metal oxide.

15. An electrochemical method of recycling and regenerating transition metal oxides, the electrochemical method comprising:
heating a mixture of salts to obtain a molten salt solution;
immersing a working electrode, a counter electrode and optionally a reference electrode into the molten salt solution, the working electrode being electrically connected to a cathode material comprising a transition metal oxide;
applying a voltage to the working electrode, whereby electrodissolution of the transition metal oxide occurs, thereby producing an alkali metal species comprising lithium or sodium ions and a transition metal species comprising transition metal ions in the molten salt solution; and
during the electrodissolution of the transition metal oxide and the application of the voltage, concurrently electrochemically producing a regenerated transition metal oxide.

16. The method of claim 15, wherein concurrently electrochemically producing the regenerated transition metal oxide comprises:
concurrently growing the regenerated transition metal oxide on the counter electrode from the alkali metal species and the transition metal species in the molten salt solution.

17. The method of claim 15, wherein concurrently electrochemically producing the regenerated transition metal oxide comprises:
concurrently precipitating a powder comprising the regenerated transition metal oxide from the alkali metal species and the transition metal species in the molten salt solution.

18. The electrochemical method of claim 15, wherein the regenerated transition metal oxide is crystalline.

19. The electrochemical method of claim 15, wherein the transition metal oxide and the regenerated transition metal oxide comprise:
a lithium transition metal oxide selected from the group consisting of: lithium cobalt oxide (LCO), lithium manganese oxide (LMO), lithium nickel manganese cobalt oxide (NMC), and lithium nickel cobalt aluminum oxide (NCA), or
a sodium transition metal oxide.

20. The electrochemical method of claim 15, wherein the cathode material is obtained from a spent or new lithium-ion or sodium-ion battery.
